(19) United States
(12) Patent Application Publication
(10) Pub. No.: US 2011/0090453 A1
(43) Pub. Date: Apr. 21, 2011

(54) Spectacles for correcting color blindness

(76) Inventors: Mou Chen, Changchuan (CN); Xiaoguang Chen, Changchuan (CN)

(21) Appl. No.: 10/563,729

(22) PCT Filed: Jul. 6, 2004
(86) PCT No.: PCT/CN2004/000756

§ 371 Date: Feb. 14, 2008

(30) Foreign Application Priority Data
Jul. 8, 2003 (CN) 03127614.8

(51) Int. Cl. G02C 7/10

(52) U.S. Cl. 351/163; 351/177

(57) ABSTRACT

Rectifying method for color blindness and the production method of rectifying eyeglasses for color blindness by using a computer to simulate the process of rectifying color blindness, improving the basic color, the color tone, and color saturation of the light entering the eye. In the rectifying of the color blindness, there are numerous kinds of spectrums and parameters of the rectifying eyeglasses for color blindness, which are then grouped under four types. The rectifying eyeglasses for color blindness change the proportion of stimulus of the three kinds of optic cone cells on the retina and alter the color codes of the visional area of the cerebral cortex, thus when the color blind viewer wears the properly chosen eyeglasses, the ability to discriminate between colors is greatly improved.

### CLAIM OF PRIORITY

The present application claims the benefit of the filing date of PCT Application Serial No. PCT/CN04/000756, (filed Jul. 6, 2004) (published as WO 05/003841) and CN 03127614.8 (filed Jul. 8, 2003), the contents of which are hereby incorporated by reference in their entirety.

### FIELD OF INVENTION

The present invention relates to spectacles for correcting color blindness and improving overall brightness of vision.

### BACKGROUND

It is said that at the present moment, over 200,000,000 people are color blind. These people are not able to differentiate between colors. They are not able to work in fields regarding fine arts, textile printing, chemical industry, traffic, geology, medicine, or national defense, etc. These circumstances became the reason that the spectacles of the present invention (e.g., eyeglasses) were created.

There are already four patents for color blindness correction lenses: Chinese Patent No. Z90110297.0, Japanese Patent No. 2813743, and U.S. Pat. No. 5,369,453. In these three patents the brightness is substantially decreased to less than 35%. The primary color ratio was adjusted but the brightness is decreased substantially and the lack of brightness may cause an adverse effect on vision. In Chinese Patent No. Z98201888.6, the invention involves adjusting one lens and leaving the other clear in order to increase the brightness. However, because of the great difference in the levels of brightness, it causes an adverse effect by exerting vision and increased problems with color blindness.

### SUMMARY

The purpose of present invention is to sole the problems mentioned above by adjusting color blindness and also adjusting the level of brightness.

In one aspect, the present invention provides a rectifying method for color blindness and the production method of rectifying eyeglasses for color blindness by using a computer to simulate the process of rectifying color blindness, improving the basic color, the color tone, and color saturation of the light entering the eye. In the rectifying of the color blindness, there are numerous kinds of spectrums and parameters of the rectifying eyeglasses for color blindness, which are then grouped under four types. The rectifying eyeglasses for color blindness change the proportion of stimulus of the three kinds of optic cone cells on the retina and alter the color codes of the visional area of the cerebral cortex, thus when the color blind viewer wears the properly chosen eyeglasses, the ability to discriminate between colors is greatly improved.

In another aspect, a computerized spectral curvature analysis machine is used to diagnose the type and grade of the color blindness by creating an individual spectral curve. The level of light that is being passed through is determined in order to improve and enhance the overall brightness. Based on the diagnosis, corrective lenses can then be made to rectify individual spectral curvatures. Corrective prescription lenses can then be created to reverse the incorrect spectral curvature and colored properly. Using a vacuum evaporation process, the proper curvature for correction is created. The lenses are then given a mirror finish with vacuum chrome plating evaporation process in order to appear identical to observers. One lens is color adjusted in order to correct the color blindness spectral curve. The other lens rectifies the lack of brightness from the color-adjusted lens and does not change the primary color ratio to let in light in order to improve the overall brightness of vision.

Further areas of applicability will become apparent from the description provided herein. It should be understood that the description and specific examples are intended for purposes of illustration only and are not intended to limit the scope of the present disclosure.

### DRAWINGS

FIG. 1 is a graph illustrating spectral characteristics of an Ag6 color blindness correcting lens; and

FIG. 2 is a graph illustrating spectral characteristics of an Arg5 brightness correcting lens.

### DETAILED DESCRIPTION

In one aspect, the present invention provides color blind corrective glasses which feature two different lenses, one that corrects the color blindness and the other that improves the overall brightness of vision.

A lens, based on spectral curvature analysis, is colored in order to correct the spectral curve that causes the color blindness. The second lens is adjusted to a range varying from 500-600 nm to improve the overall brightness of vision.

A computerized spectral curvature analysis machine is used to diagnose the type and grade of the color blindness by creating an individual spectral curve. Then, the level of light that is being passed through is determined in order to improve and enhance the overall brightness. Based on the diagnosis, corrective lenses can then be made to rectify individual spectral curvatures. Corrective prescription lenses can then be created to reverse the incorrect spectral curvature and color properly. Using a vacuum evaporation process, the proper curvature for correction is created. The lenses may then be given a mirror finish with vacuum chrome plating evaporation process in order to appear identical to observers. One lens is color adjusted in order to correct the color blindness spectral curve, while the other lens rectifies the lack of brightness from the color adjusted lens and does not change the primary color ratio to let in light in order to improve the overall brightness of vision.

When the proportion of stimulation to three kinds of optic cone cells is changed externally, the codes of visional area of cerebral cortex are changed and thus the ability of discrimination between two color objects is improved. According to the spectral absorptive peak values of standard Red, Green and Blue optic cone cells, the subordinate function of subsets of spectral curves for three kinds of optic cones cells R (red), G (green), and B (blue). The information of R, G and B processes in the matrix transformation in the retina and the brightness signal and color signals are modulated.

L=L_{R}(R)+L_{G}(g)+L_{B}(B)

U=Ku·(R−L)

V=Kv·(B−L)

The luminance coefficient is defined as Lr, Lg, and Lb. Therefore, Lr+Lg+Lb=1. U is the chromatic aberration signal for red, Vr is the blue aberration chromatic signal and Ku and Kv are the vector factor. The L, U and V signals, there are three kinds of optic nerve fibers where the size differs, passes through an intersection and is conveyed to the cell layer in the outer part of the geniculate body. Here, L, U and V are deciphered to become primary color signals once again.

R=U/K_{U}+L

G=L−(L_{g}/L_{G}) (U/K_{U})−(L_{G}/L_{B}) (V/K_{Y})

B=V/K_{V}+L

R, G and B, depending on the apparent radiation, are transmitted to the cerebral cortex. The cerebral cortex, depending on specific color and the three-dimensional coordinate, with the direction and size

[symbol]

and color is defined, color vision is generated. If the process which humans recognize colors is abnormal, receiving the value of the primary colors where the cerebral cortex's Ku is abnormal, it starts to bear a color vision with specific color definition that is incorrect therefore causing a color vision abnormality. If the cerebral cortex cannot receive the signal for the primary colors, the patient loses all color impressions. This is called total color blindness. If the patient loses two of the three primary color functions, there is an apparent Ku decrease and the red, green or blue are defined as Ar, Ag and Ab. If one of the three primary colors is affected, there is an apparent Ku decrease and red, green and blue are defined as Br, Bg and Bb. With the exception of total color blindness, there are six types of color blindness. If affected externally by changing the primary color ratio, the cerebral cortex will receive normal color vision thereby achieving the correction of color blindness by rectifying the incorrect primary color ratio.

This invention and correction principle is as follows: The brightness defined as L which designates the stimulus value of the light of the three primary colors in normal color vision defined as R, G and B. U and V are the chromatic aberrations. The signal of the three primary colors, which is deciphered by the outer geniculate body, is conveyed to the cerebral cortex as Ku.

[symbol]

=R, [symbol] =G, [symbol] =B

Therefore, the color vision formula that the cerebrum receives is:

[symbol]

(λ)= [symbol] =\sqrt{R²+G²+B²}

The color blind patients' signals are defined as r, g and b and the brightness is defined as

l

and the chromatic aberrations are defined as u and v. The spectral characteristic curve is corrected with two lenses, one rectifying the transmission of the 3 primary colors:

r̅, g̅, b̅

And the other rectifying the brightness:

r̅′̅, g̅′̅, b̅′̅

The brightness of the primary color correction lens is defined as;

l̅

And the chromatic aberration signals are defined as;

ū, v̅

Therefore,

l̅=Lᵣ r̅·r+L_{g} g̅·g+L_{b} b̅·b (1)

ū=Kᵤ( r̅·r− l̅) (2)

v̅=Kᵥ( b̅·b− l̅) (3)

In addition, when brightness correction lens is installed the brightness signal is defined as:

l̅′̅

And the chromatic aberration signals are defined as:

u̅′̅, v̅′̅

Therefore

l̅′̅=L_{r′} r̅′̅·r+L_{g′} g̅′̅·g+L_{b′} b̅′̅·b (4)

u̅′̅=K_{u′}( r̅′̅·r− l̅′̅) (5)

v̅′̅=K_{v′}( b̅′̅·b− l̅′̅) (6)

(4), depending on (2) and (3), and understanding the outer geniculate body

$$\overline{{𝓁}^{′}} = {L}_{r} \overline{{r}^{′}} \cdot r + {L}_{g} \overline{{g}^{′}} \cdot g + {L}_{b} \overline{{b}^{′}} \cdot b$$

$$\overline{u} = {K}_{u} ( \overline{r} \cdot r - \overline{𝓁} )$$

$$\overline{v} = {K}_{v} ( \overline{b} \cdot b - \overline{𝓁} )$$

$$\frac{\overline{{𝓁}^{′}}}{𝓁} \overline{u} = \overline{U} , \frac{\overline{{𝓁}^{′}}}{𝓁} \overline{v} = \overline{V} , \frac{\overline{{𝓁}^{′}}}{𝓁} \overline{r} r = \overline{R} , \frac{\overline{{𝓁}^{′}}}{𝓁} \overline{b} b = \overline{B}$$

When with the above, (2) and (3) changes like below:

Ū=Kᵤ( R̅− l̅′̅) (2′)

V̅=Kᵥ( R̅− l̅) (3′)

Therefore from (4), (2′), (3′) the solution becomes:

R̅=Ū/K_{U}+ l̅′̅ (7)

G̅= l̅′̅−(L_{R}/L_{G}) (Ū/K_{U})−(L_{b}/L_{g}) ( V̅/K_{V}) (8)

B̅= V̅/K_{V}+ l̅′̅ (9)

l̅′̅→L

Inevitably becoming:

R̅→R, G̅→G, B̅→B

With it becomes corrected cerebral eyesight defined as;

[symbol]

(λ)= [symbol] ≈\sqrt{R̅²+ G̅²+ B̅²}

Color blindness is corrected.

The present invention is based on a physiological mechanism and can offer color blindness correcting glasses which can adjust basic color, color tone, saturation of color vision and brightness to achieve true correction of color blindness.

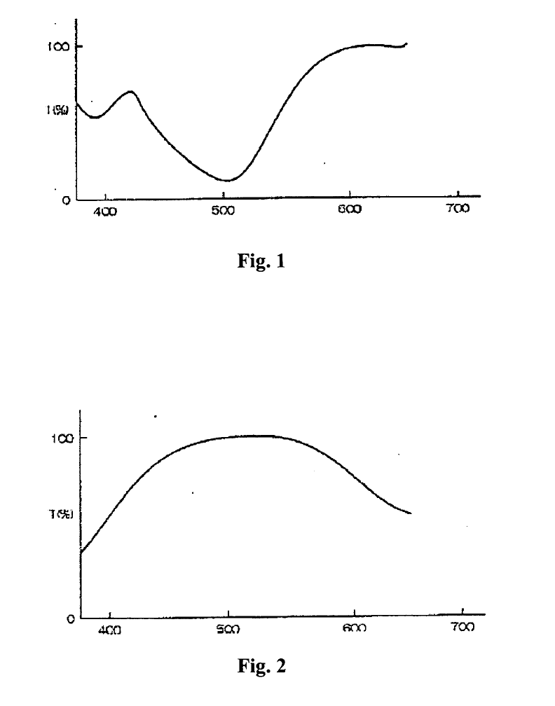

There are six different types of color blindness and six grades of each type. The correction method is the same. Using the computerized spectral curvature analysis machine, the spectral characteristic can be determined at which time the brightness correction is automatically generated at the same time and the prescription for the lenses can be found. For example, refer to FIG. 1 and FIG. 2.

Computerized spectral curvature analysis machine is used to diagnose the type and grade of the color blindness by creating an individual spectral curve. Then the level of light that is being passed through is determined in order to improve and enhance the overall brightness. Based on the diagnosis, corrective lenses can then be made to rectify individual spectral curvatures. Corrective prescription lenses can then be created to reverse the incorrect spectral curvature and color properly. Using a vacuum evaporation process, the proper curvature for correction is created. The lenses may then be given a mirror finish with vacuum chrome plating evaporation process in order to appear identical to observers. One lens is color adjusted in order to correct the color blindness spectral curve, while the other lens rectifies the lack of brightness from the color adjusted lens and does not change the primary color ratio to let in light in order to improve the overall brightness of vision. Tests are then conducted after the corrections have been made.

To test for proper vision correction with the colorblindness rectifying lenses, a color vision inspection machine screen is used. The colors are then tested one at a time. The screen is lit up with one color (red, green or blue). The brightness of the color is increased and then decreased to see whether the difference can be detected by the patient. Ideally, the top and bottom halves should be at the same brightness. This measures whether the brightness adjustment lens has been measured properly.

When testing for chromatic aberrations, a white equilibrium and color distribution ratio inspection is done with the color vision inspection machine. In order to see the true white, the ratio of the three primary colors red, green and blue should be equal or R=G=B. When the brightness reaches the maximum, the retina deciphers the two chromatic aberration signals as U=0 and V=0. The outer geniculate body then reads the primary colors as R=L, G=L and B=L. It is then that the cerebral cortex will define this as white. After the adjustment:

[symbol]

The brightness becomes normal therefore the chromatic aberrations become:

[symbol]

=0, [symbol] =0

The outer geniculate body reads it as:

[symbol]

Thus:

[symbol]

= L̅′̅, [symbol] = L̅′̅, [symbol] = L̅′̅

Then:

{grave over ( L̅′̅−L

The color correction that the patient sees is therefore normal. The white becomes true. Using the R+G+B ratio, the upper half of the screen which shows a true white should match the lower half with the R+G+B ratio. Color tone ratios can also be measured this way.

Finally, with the color blindness rectifying glasses on, the patient is tested with the 24-color vision-testing book. If the prescription is truly correct, the patient will have normal color vision.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1-4. (canceled)

5. A system for correcting color blindness comprising:
spectacles having a first and a second lens;
wherein the first lens is configured to correct colorblindness and the second lens is configured to improve an overall brightness of vision.

6. The apparatus of claim 1, further comprising a processing device for creating an individual spectral curve, wherein the color of said first lens is adjusted using said individual spectral curve.

7. The apparatus of claim 1, wherein said second lens has an adjusted range of brightness varying from 500-600 nm.

8. A method for correcting color blindness comprising the steps of:
creating an individual spectral curve based on the type and grade of a users color blindness;
determining a level of light for enhancing brightness;
creating spectacles having a first and second lens based on said individual spectral curve and said level of light; wherein said first lens is adjusted based on said individual spectral curve and said second lens is adjusted based on said level of light; and
placing said first and second lens under a vacuum chrome plating process.
